(19) United States
(12) Patent Application Publication
(10) Pub. No.: US 2007/0179963 A1
(43) Pub. Date: Aug. 2, 2007

(54) COMPUTER SYSTEM INCORPORATING DUPLICATED DATABASE SERVERS

(76) Inventors: Kenichirou Fujiyama, Tokyo (JP); Nobutatsu Nakamura, Tokyo (JP); Ryuichi Hiraike, Tokyo (JP)

Correspondence Address: DICKSTEIN SHAPIRO LLP, 1177 AVENUE OF THE AMERICAS (6TH AVENUE), NEW YORK, NY, 10036-2714, US

(21) Appl. No.: 11/460,858

(22) Filed: Jul. 28, 2006

(30) Foreign Application Priority Data
Jan. 27, 2006 (JP) 2006-018712

(51) Int. Cl. G06F 7/00

(52) U.S. Cl. 707/101

(57) ABSTRACT

A computer system is composed of a plurality of application servers each installed with an application program configured to issue data processing requests; and a plurality of database servers. Each of the database servers is composed of a storage, and installed with a database server middleware receiving the data processing requests and a DBMS managing data stored in the storage. Each of the data processing requests is duplicatedly forwarded to each of the database servers. The data processing requests received by the database middlewares are respectively assigned with sequence numbers uniquely defined over the whole of the computer system. The database server middleware converts the data processing requests received into corresponding DBMS-specific data processing requests, and forwards the DBMS-specific data processing requests in an order indicated by the sequence numbers.

### BACKGROUND OF THE INVENTION

1. Field of the Invention

The present invention relates to a computer system, more particularly to a computer system incorporating two or more duplicated database servers for avoiding loss of data.

2. Description of the Related Art

Various computer systems provided with one or more application servers and database servers are proposed or commercially available, as disclosed in Japanese Laid Open Patent Application No. Jp 2005-165610. In such a computer system, data stored in the database server are referred or updated in response to operations of an application program run on the application servers. In a computer system thus designed, data replication is of significance to avoid loss of data stored in the database servers.

The inventors has disclosed a computer system supporting data replication in “Enhanced Java-API for Synchronous Database Replication”, Information Processing Society of Japan, 67-th National Meeting, 1K-5, 2005, and in “Enhanced Database Connection API for Synchronous Data Replication between Different Database Softwares”, FIT 2005, 4-th Information Technology Forum, C-031, 2005.

Referring to FIG. 1, the disclosed conventional computer system is composed of an application server 1300 for providing various services, a primary database server 1100 for providing data for the application server 1300, and a backup database server 1200 functioning as a duplicated server of the primary database server 1100.

The primary server 1100 is provided with a storage 1120 storing desired data, and a database management system (DBMS) 1110 managing the data stored in the storage 1120.

Correspondingly, the backup server 1200 is provided with a storage 1220 storing data, and a DBMS 1210 managing the data stored in the storage 1220.

The application server 1300 is installed with an application 1310 which issues data processing requests to the DBMSs 1110 and 1210, and a middleware 1320 commonly providing functions for multiple applications, including the application 1310. The middleware 1320 includes database (DB) connection modules 1321 and 1322, and a duplication module 1323. In general, the interfacing between the DB connection modules 1321 and 1322 and the applications 1310 is typically achieved by a standardized interface, such as JDBC (Java™ Database Connectivity).

On the other hand, the interfacing between the DB connection modules 1321 and 1322 and DBMSs 1110 and 1210 is achieved by an interface specific to the DBMSs 1110 and 1210.

Since the duplication module 1323 is provided with a standardized interface, the duplication module 1323 is recognized as a DB connection module by the applications 1310, and recognized as an application by the DB connection modules 1321 and 1322. In other words, the duplication module 1323 is “transparent” for other software modules; other software modules do not perform any special processing for the duplication module 1323.

The conventional computer system operates as follows:

When desiring the DBMS 1110 to perform data processing, the application 1310 issues a standard data processing request adapted to the standardized interface within the DB connection modules through the middleware 1320.

When the middleware 1320 receives the standard data processing request, the duplication module 1323 duplicates the data processing request, and forwards one of the duplicated data processing requests to the DB connection module 1321, and another to the DB connection 1322, respectively.

The DB connection module 1321 converts the data processing request received from the duplication module 1323 into a DBMS-specific data processing request adapted to the primary DBMS 1110, while the DB connection module 1322 converts the data processing request received from the duplication module 1323 into a DBMS-specific data processing request adapted to the backup DBMS 1210. The DBMS-specific data processing requests are forwarded to the associated one of the DBMSs 1110 and 1210.

The primary DBMS 1110 and the backup DBMS 1210 perform the same data processing in response to the DBMS-specific data processing requests logically identical to each other. As a result, the data in the primary storage 1120 and the backup storage 1220 are subjected to the same data processing; the data in the primary storage 1120 and the backup storage 1220 are kept identical. The above-described data processing is equivalent to data replication between the primary storage 1120 and the backup storage 1220.

One advantage of the above-described computer system architecture is easy installation. The above-described computer system architecture allows an existing computer system consisting of an application server 1300 and a primary database server 1100 to be easily updated to support data replication by additionally providing a duplication module 1323, a database connection module 1322, and a backup DB server 1200.

Another advantage is that the duplication module 1323 is widely applicable to various computer systems regardless of the kinds of the application 1310 and the DBMS 1110, since the duplication module 1323 duplicates the standard data processing request before the conversion into the DBMS-specific data processing request.

Still another advantage is that the above-described computer system architecture allows continuously providing desired services; when one of the database servers 1100 and 1200 experiences trouble, the other provides desired data for the application 1310.

Nevertheless, the above-described computer system architecture suffers from a problem that the computer system may suffer from unsuccessful data replication, when there are multiple connections to a single DBMS, such as when multiple application servers are connected to a single DBMS.

The above-described computer system achieves data replication by requesting the primary and backup DBMSs to perform the same data processing. Therefore, it is necessary that the order in which the primary DBMS receives the data processing requests is identical to the order in which the backup DBMS receives the data processing requests. When a single DBMS is connected to a single application server, there is no possibility in which the order of the issued data processing requests is different from the order of the received data processing requests. In the case that two or more application servers are connected with each of the primary and backup DBMSs, however, the order of the primary DBMS receiving the data processing requests issued by the respective applications may be different from the order of the backup DBMS receiving the data processing requests, due to the network delay and the like, because the connections between the application servers and the DBMSs are independent from each other.

For the case shown in FIG. 2, for example, the primary DBMS 2110 receives a data processing request 1-2 after receiving a data processing request 1-1, while the backup DBMS 2210 receives another data processing request 2-1 before the data processing request 1-2 reaches the backup DBMS 2210 through a different connection, after receiving the data processing request 1-1. The difference in the order of the reception of the data processing requests may cause different data processing results and data inconsistency, resulting in unsuccessful data replication.

Japanese Laid Open Patent Application No. Jp-Showa 60-237551A discloses a distributed database system in which transactions issued by multiple workstations are processed by multiple sites in the same order by identifying the order of processing the transactions by sequence numbers assigned to the respective transactions; the sites processes the transactions in the order indicated by the sequence numbers. If this approach is applied to the system shown in FIG. 12, one implementation may be that sequence numbers are assigned to the data processing requests transmitted from the DB connection modules 1321 and 1322 to the DBMSs 1110 and 1210, and the DBMSs 1110 and 1210 performs processing in the order indicated by the sequence numbers.

However, this implementation encounters a difficulty as follows: The interfaces with the DBMSs 1110 and 1210 prepared in the DB connection modules 1321 and 1322 are designed to be specific to the DBMSs 1110 and 1210; the protocol used in the interfaces is also specific to the DBMSs 1110 and 1210. Therefore, allocating the sequence numbers to the data processing requests requires modifying the DBMS-specific protocol. This modification of the DBMS-specific protocol requires update of the DBMSs 1110 and 1210. The update of the DBMSs 1110 and 1210 is not easy from the practical viewpoint. Additionally, the update of the DBMSs 1110 and 1210 results in DBMS-specific ad-hoc implementation, and therefore, it is not easy to apply the update of the DBMSs 1110 and 1210 to a computer system incorporating a different kind of DBMSs.

Japanese Laid Open Patent Application No. Jp 2002-108681 discloses a technique for data replication from multiple master tables to a single replica table. This document is silent on the problem in connection with the order of data processing requests.

Japanese Laid Open Patent Application No. Jp Heisei 9-259024 discloses a system in which multiple HMI (human machine interface) terminals are connected to a single common database server. This document is silent on duplication of database servers.

### SUMMARY OF THE INVENTION

Therefore, an object of the present invention is to provide a computer system installed with DBMSs each connected to multiple application servers, in which a primary DBMS and a backup DBMS(s) receive data processing requests in the same order, and thereby achieves consistent data replication without modification of the DBMS-specific interface protocol.

In an aspect of the present invention, a computer system is composed of a plurality of application servers each installed with an application program configured to issue data processing requests; and a plurality of database servers. Each of the database servers is composed of a storage, and installed with a database server middleware receiving the data processing requests and a DBMS managing data stored in the storage. Each of the data processing requests is duplicatedly forwarded to each of the database servers. The data processing requests received by the database middlewares are respectively assigned with sequence numbers uniquely defined over the whole of the computer system. The database server middleware converts the data processing requests received into corresponding DBMS-specific data processing requests, and forwards the DBMS-specific data processing requests in an order indicated by the sequence numbers.

The computer system may further include a data processing request control server connected between the application servers and the database servers. In this case, the data processing request control server is preferably configured to attach the data processing requests with assigned ones of the sequence numbers, to duplicate each of the data processing requests attached with the sequence numbers, and to forward the duplicated data processing requests to each of the database servers.

The computer system may further include a sequence control server assigning the sequence numbers to the data processing requests issued by the application programs.

Instead, the application servers may each include a sequence number negotiating module. In this case, one of the sequence number negotiating modules negotiates with other(s) of the sequence number negotiating modules to achieve assignment of the sequence numbers to the data processing requests.

In one embodiment, the computer system may further incorporate a sequence number control server including a sequence number control module assigning the sequence numbers uniquely defined to the data processing requests issued by the application programs. In this case, the plurality of application servers may each include application server middleware comprising: a sequence number acquiring module acquiring the sequence numbers from the sequence control server; and a control module configured to attach the data processing requests received from the application program with the sequence numbers, to duplicate the data processing requests attached with the sequence numbers, and to forward each of the duplicated data processing requests to each of the database servers. The database server middleware comprises: a sequence control module rearranging an order of the data processing requests attached with the sequence numbers, in response to the sequence numbers; and a DB connection module converting the data processing requests received into the DBMS-specific data processing requests.

Alternatively, the computer system may further include a sequence control server; and a data processing request control server connected between the application servers and the database servers. In this case, the sequence control server includes a sequence number control module assigning the sequence numbers uniquely defined to the data processing requests received by the database middlewares. The plurality of application servers each includes application server middleware forwarding the data processing requests received from the application program to the data processing request control server. The data processing request control server includes a control module configured to attach the data processing requests received from the application server middleware with the sequence numbers, to duplicate the data processing requests attached with the sequence numbers, and to forward each of the duplicated data processing requests to each of the database servers. The database server middleware comprises: a sequence control module rearranging an order of the data processing requests attached with the sequence numbers, in response to the sequence numbers; and a DB connection module converting the data processing requests received from the sequence control module into the DBMS-specific data processing requests.

Instead, the plurality of application servers may each include application server middleware comprising: a sequence number negotiating module negotiating with other one(s) of the application servers to achieve assignment of the sequence numbers to the data processing requests; and a control module configured to attach the received data processing requests with the sequence numbers, to duplicate the data processing requests attached with the sequence numbers, and to forward each of the duplicated data processing requests to each of the database servers. In this case, the database server middleware comprises: a sequence control module rearranging an order of the data processing requests attached with the sequence numbers, in response to the sequence numbers; and a DB connection module converting the data processing requests received into the DBMS-specific data processing requests.

In another aspect of the present invention, a method of achieving data replication comprising:

issuing data processing requests by application programs within a plurality of application servers;

assigning sequence numbers to the respective data processing requests;

duplicatedly forwarding each of the data processing requests attached with the sequence numbers to each of database servers;

converting the data processing requests attached with the sequence numbers into corresponding DBMS-specific data processing requests; and

forwarding the DBMS-specific data processing requests to DBMSs within the database servers in an order indicated by the sequence numbers.

The duplicated forwarding may be implemented by application server middlewares installed within the application servers, respectively.

Alternatively, the duplicated forwarding may be implemented by a data processing request control server connected between the application servers and the database servers.

The assignment of the sequence numbers may be implemented by a sequence control server.

Alternatively, the application servers may be respectively installed with application server middlewares each including a sequence number negotiating module, and the assignment of the sequence numbers is achieved through negotiation between or among the sequence number negotiating modules.

In still another aspect of the present invention, an application server is composed of: an application program configured to issue data processing requests, and middleware. The middleware includes a sequence number acquiring module receiving sequence numbers assigned to the data processing requests from a sequence control server; and a control module configured to attach the received data processing requests with the sequence numbers, to duplicate the data processing requests attached with the sequence numbers, and to forward each of the duplicated data processing requests to each of a plurality of database servers.

In still another aspect of the present invention, an application server is composed of an application program configured to issue data processing requests, and middleware. The middleware includes: a sequence number negotiating module negotiating assignment of sequence numbers to the data processing requests with at least one other sequence number negotiating module installed in at least one other application server; and a control module configured to attach the data processing requests with the sequence numbers, to duplicate the data processing requests attached with the sequence numbers, and to forward each of the duplicated data processing requests to each of a plurality of database servers.

In still another aspect of the present invention, a data processing request control server is composed of: a sequence number acquiring module receiving sequence numbers from a sequence control server, the sequence numbers being assigned to data processing requests issued by application programs installed in application servers; and a control module configured to attach the data processing requests with the sequence numbers, to duplicate the data processing requests attached with the sequence numbers, and to forward each of the duplicated data processing requests to each of a plurality of database servers.

In still another aspect of the present invention, a database server is composed of a storage; a DBMS managing data stored in the storage; and middleware configured to receive data processing requests attached with sequence numbers from a plurality of application servers. The middleware includes: a sequence control module rearranging an order of the data processing requests attached with sequence numbers, in response to the sequence numbers; and a DB connection module converting the data processing requests received from the sequence control module into DBMS-specific data processing requests, and forwarding the DBMS-specific data processing requests in an order indicated by the sequence numbers to the DBMS.

In still another aspect of the present invention, a database server is composed of a storage; DBMS managing data stored in the storage; and middleware configured to receive data processing requests attached with sequence numbers from a data processing request control server. The middleware includes: a sequence control module rearranging an order of the data processing requests attached with sequence numbers, in response to the sequence numbers; and a DB connection module converting the data processing requests received from the sequence control module into DBMS-specific data processing requests, and forwarding the DBMS-specific data processing requests in an order indicated by the sequence numbers to the DBMS.

In still another aspect of the present invention, a computer-readable medium records a program for an application server. The program is composed of: a code module for receiving sequence numbers assigned to data processing requests issued by an application program installed in the application server, from a sequence control server; and a code module for attaching the received data processing requests with the sequence numbers, for duplicating the data processing requests attached with the sequence numbers, and for forwarding each of the duplicated data processing requests to each of a plurality of database servers.

Alternatively, the program may be composed of: a code module for negotiating assignment of sequence numbers to data processing requests issued by an application program installed in the application server with at least one other sequence number negotiating module installed in at least one other application server; and a code module for attaching the data processing requests with the sequence numbers, for duplicating the data processing requests attached with the sequence numbers, and for forwarding each of the duplicated data processing requests to each of a plurality of database servers.

In still another aspect of the present invention, a computer-readable medium recording a program for a data processing request control server. The program is composed of: a code module for receiving sequence numbers from a sequence control server, the sequence numbers being assigned to data processing requests issued by application programs installed in application servers; and a code module for attaching the data processing requests with the sequence numbers, for duplicating the data processing requests attached with the sequence numbers, and for forwarding each of the duplicated data processing requests to each of a plurality of database servers.

In still another aspect of the present invention, a computer-readable medium records a program for a database server including a storage and a DBMS managing data stored in the storage. The program is composed of: a code module for receiving data processing requests attached with sequence numbers from a plurality of application servers; a code module for rearranging an order of data processing requests attached with sequence numbers, in response to the sequence numbers; and a code module for converting the data processing requests received from the sequence control module into DBMS-specific data processing requests, and for forwarding the DBMS-specific data processing requests in an order indicated by the sequence numbers to the DBMS.

Instead, the program may be composed of a code module for receiving data processing requests attached with sequence numbers from a data processing request control server; a code module for rearranging an order of data processing requests attached with sequence numbers, in response to the sequence numbers; and a code module for converting the data processing requests received from the sequence control module into DBMS-specific data processing requests, and for forwarding the DBMS-specific data processing requests in an order indicated by the sequence numbers to the DBMS.

### BRIEF DESCRIPTION OF THE DRAWINGS

The above and other advantages and features of the present invention will be more apparent from the following description taken in conjunction with the accompanied drawings, in which:

FIG. 1 is a block diagram illustrating the structure of a conventional computer system;

FIG. 2 is a block diagram illustrating the structure of another conventional computer system incorporating multiple application servers;

FIG. 3 is a block diagram illustrating the structure of a computer system in a first embodiment of the present invention;

FIGS. 4A and 4B are flowcharts illustrating the operation of the computer system in the first embodiment;

FIG. 5 is a block diagram illustrating the structure of a computer system in a second embodiment of the present invention;

FIGS. 6A and 6B are flowcharts illustrating the operation of the computer system in the second embodiment;

FIG. 7 is a block diagram illustrating the structure of a computer system in a third embodiment of the present invention;

FIGS. 8A and 8B are flowcharts illustrating the operation of the computer system in the third embodiment; and

FIGS. 9 to 13 are block diagrams illustrating preferred modified structures of the computer system in accordance with the present invention.

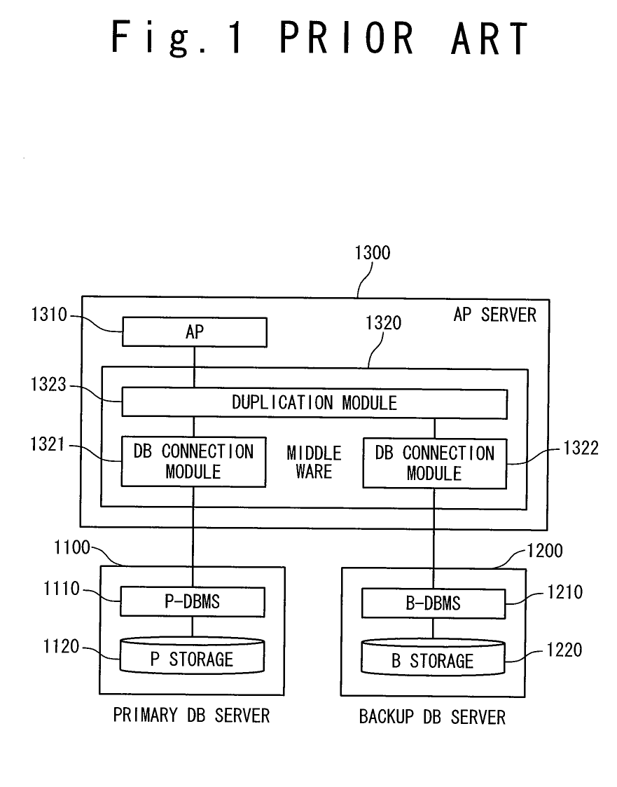

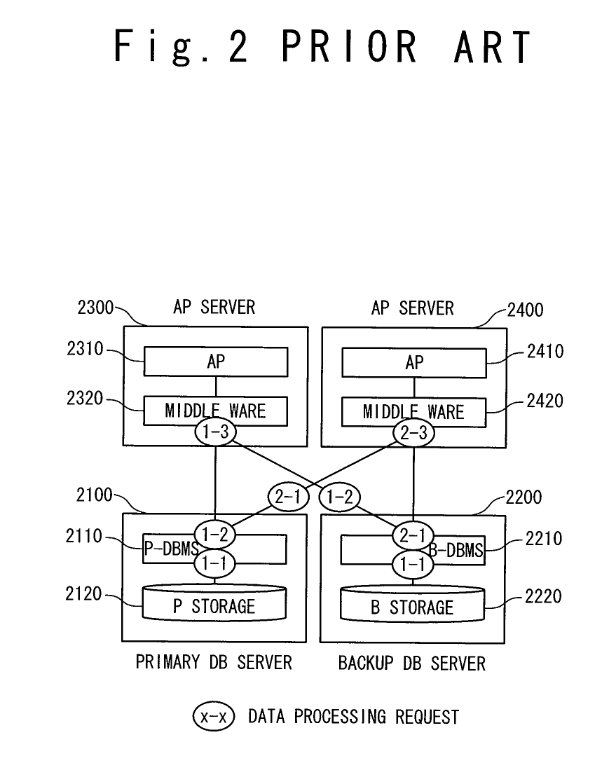

### DESCRIPTION OF THE PREFERRED EMBODIMENTS

Preferred Embodiments of the present invention will be described below in detail with reference to the attached drawings.

### First Embodiment

### (System Structure)

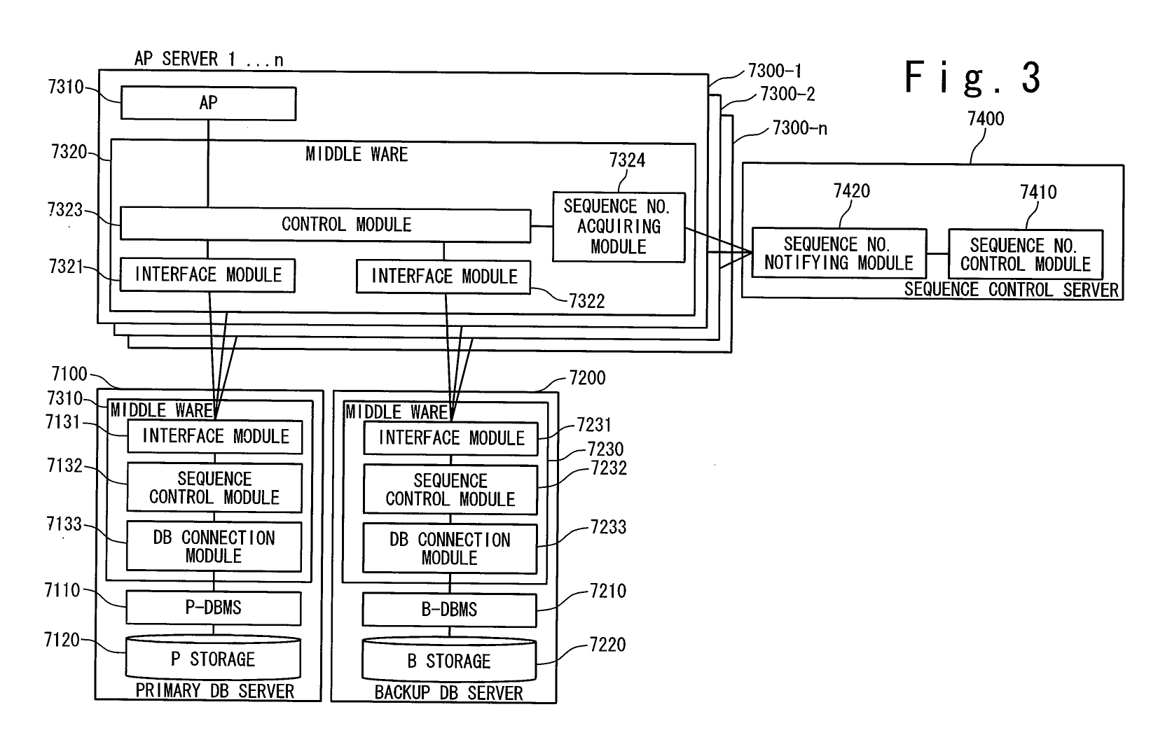

In a first embodiment, as shown in FIG. 3, a computer system is composed of multiple application servers 7300-1 to 7300-n, a primary database server 7100, a backup database server 7200, and a sequence control server 7400. The application servers 7300-1 to 7300-n provide desired services for users. The primary database server 7100 provides desired data for the application servers 7300-1 to 7300-n. The backup database server 7200 functions as a duplicate of the primary database server 7100. The sequence control server 7400 manages the order of data processing requests issued by the application servers 7300-1 to 7300-n through assigning sequence numbers to the respective data processing requests. The application servers 7300-1 to 7300-n, the database servers 7100, 7200, and the sequence control server 7400 may be implemented as physically separate computers, or as a single computer.

The primary database server 7100 is provided with a storage 7120 storing data, a DBMS 7110 managing the data in the storage 7120, and a middleware 7130 accommodating data processing requests.

The middleware 7130 includes an interface module 7131, a sequence control module 7132, and a DB connection module 7133. The interface module 7131 receives standard data processing requests from the application servers 7300-1 to 7300-n, and transmits data processing responses to the application servers 7300-1 to 7300-n. The sequence control module 7132 controls the order of processing the data processing requests on the basis of the sequence numbers attached therewith. The DB connection module 7133 converts the standard data processing requests into DBMS-specific data processing requests, and converts DBMS-specific data processing responses into standard data processing requests.

The backup database server 7200 is designed identically to the primary database server 7200. The backup database server 7200 is provided with a storage 7220 storing data, a DBMS 7210 managing the data in the storage 7220, and a middleware 7230 accommodating data processing requests.

The middleware 7230 includes an interface module 7231, a sequence control module 7232, and a DB connection module 7233. The interface module 7231 receives standard data processing requests from the application servers 7300-1 to 7300-n, and transmits data processing responses to the application servers 7300-1 to 7300-n. The sequence control module 7232 controls the order of processing the data processing requests on the basis of the sequence numbers attached therewith. The DB connection module 7233 converts the standard data processing requests into DBMS-specific data processing requests, and converts DBMS-specific data processing responses into standard data processing requests.

The application servers 7300-1 to 7300-n are each provided with an application program 7310 (hereinafter, simply referred to as application 7310), and a middleware 7320 commonly providing functions for multiple applications, including the application 7310.

The middleware 7320 includes interface modules 7321 and 7322, a control module 7323, and a sequence number acquiring module 7324. The interface modules 7321 and 7322 transmits data processing requests to the database servers 7100 and 7200, and receives data processing responses from the database servers 7100 and 7200. The control module 7323 is designed to capture data processing requests from the application 7310, to duplicate the captured data processing requests, and to attach sequence numbers to the data processing requests. Additionally, the control module 7323 is designed to capture data processing responses from the database servers 7100 and 7200, and to forward the captured data processing responses to the application 7310. The sequence number acquiring module 7324 receives sequence numbers from the sequence control server 7400.

The sequence control server 7400 is provided with a sequence number control module 7410, and a sequence number notifying module 7420. The sequence number control module 7410 manages sequence numbers so that the sequence numbers are uniquely defined over the whole of the computer system. The sequence number notifying module 7420 notifies the defined sequence numbers in response to requests from the application servers 7300-1 to 7300-n.

### (System Operation)

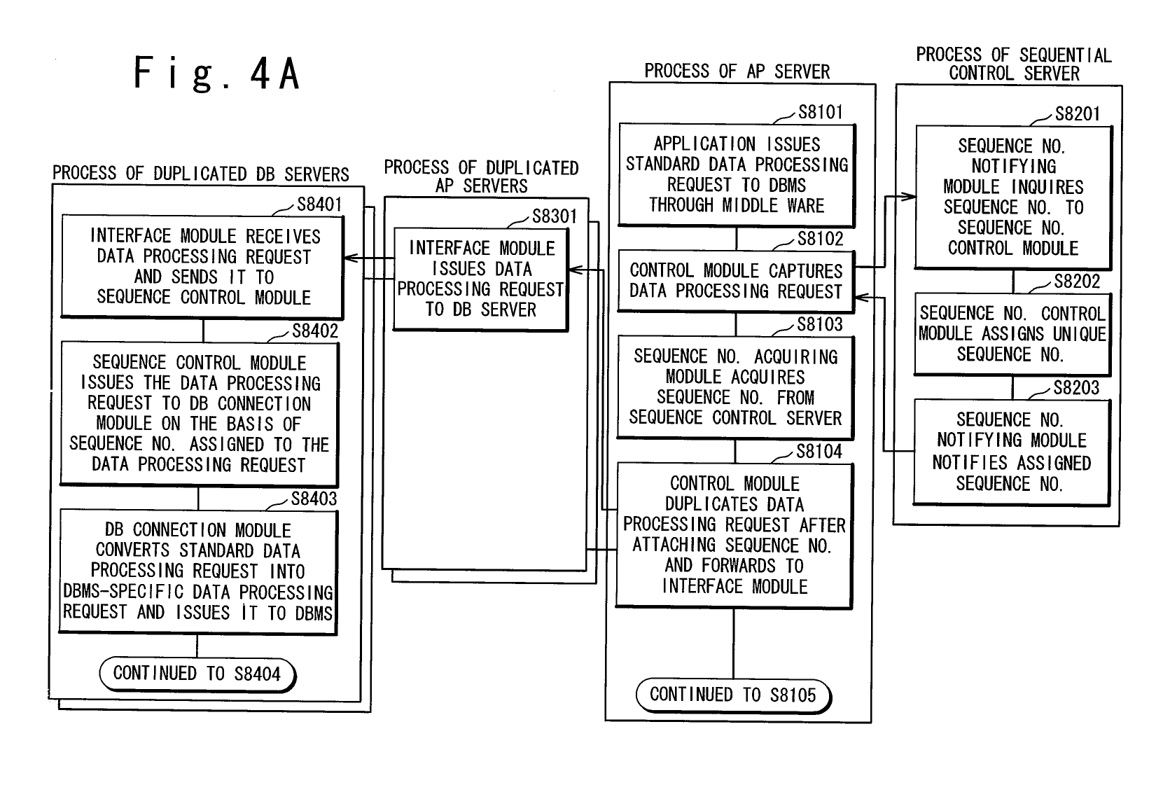

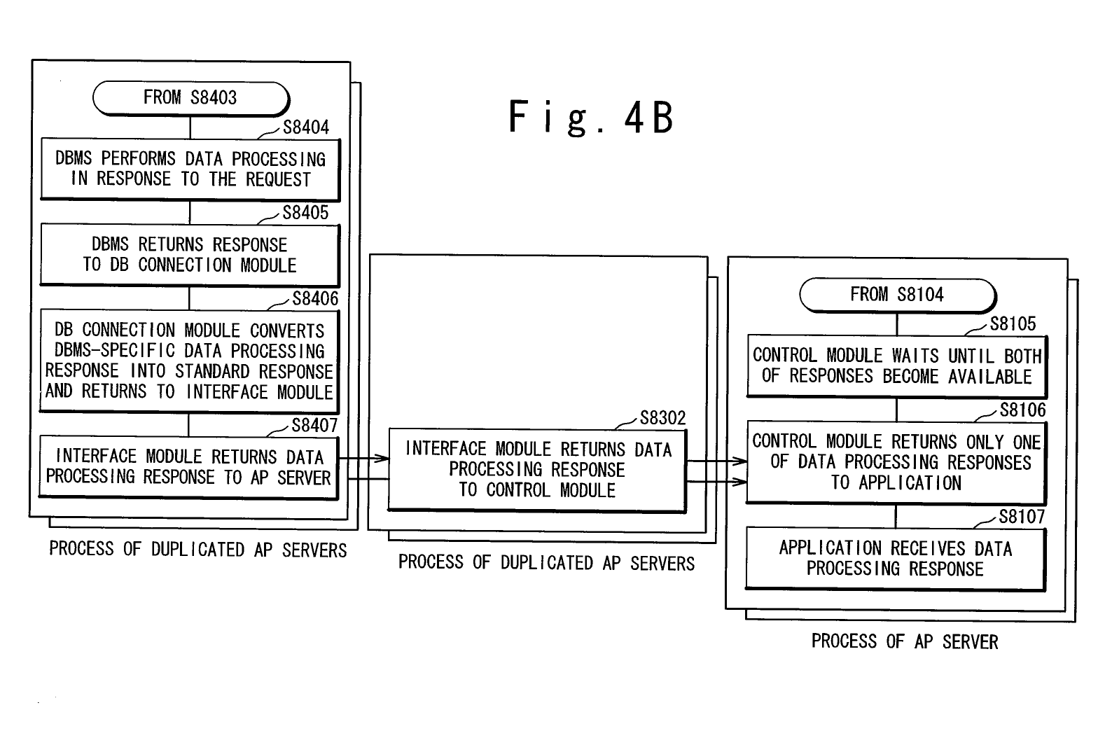

FIGS. 4A and 4B are flowcharts illustrating the operation of the computer system in this embodiment.

The application 7310 within the application server 7300-i issues a standard data processing request to the middleware 7320 at Step S8101, when requesting data processing to the primary DBMS 7100. The issued standard data processing request is adapted to the standardized interface used by the DB connection modules 7133.

Upon the middleware 7320 receiving the standard data processing request, the control module 7323 temporarily captures the standard data processing request at Step S8102. In a commonly-used computer system, a DB connection module is incorporated within a middleware within an application server, and an application within the application server issues a data processing request adapted to the standardized interface used by the DB connection module. In this embodiment, the application 7310 recognizes the control module 7323 equivalently to the database connection module 7133, because the control module 7323 is installed with a standardized interface identically to the DB connection module 7133. Therefore, the application 7310 does not perform any special operation for the control module 7323; the control module 7323 is “transparent” from the application 7310.

In response to the data processing request being captured by the control module 7323, the sequence number acquiring module 7324 acquires a sequence number assigned to the captured data processing request, from the sequence control server 7400 at Step S8103. Specifically, the sequence number notifying module 7420 within the sequence control server 7400 receives a sequence number assignment request from the sequence number acquiring module 7324, and makes an inquiry about a sequence number to be assigned to the captured data processing request to the sequence number control module 7410. In response to the inquiry, the sequence number control module 7410 assigns a sequence number uniquely defined over the system to the relevant data processing request. In the present computer system, only the sequence number control module 7410 is authorized to assign sequence numbers. Therefore, assigning unique sequence numbers to the data processing requests is achieved by simply issuing serial numbers. The sequence number notifying module 7420 notifies the assigned sequence number to the sequence number acquiring module 7324 at Step S8203.

The control module 7323 within the application server 7300-i attaches the assigned sequence number to the data processing request captured therein, and duplicates the data processing request attached with the sequence number at Step S8104. One of the duplicated data processing requests is forwarded to the interface module 7321, and the other is forwarded to the interface module 7322. Attaching the sequence number to the data processing request requires format conversion of data processing requests, and protocol modification of issuing data processing requests; however, the format conversion and protocol modification is easily achieved, because the specification of the protocol of issuing data processing requests by application servers is standardized and disclosed in the public domain, differently from the protocol of issuing data processing requests by DB connection modules; the specification of issuing data processing requests by DB connection modules is not disclosed in the public domain.

The interface module 7321 receives the data processing request attached with the sequence number, and forwards the received request to the primary database server 7100 at Step S8301. Correspondingly, the interface module 7322 receives the data processing request attached with the sequence number, and forwards the received request to the backup database server 7200.

In the database servers 7100 and 7200, the interface modules 7131 and 7232 within the middlewares 7130 and 7230 forwards the data processing requests attached with the sequence numbers to the sequence control module 7132 and 7232, respectively, at Step S8401.

The sequence control modules 7132 and 7232 rearrange the order of the data processing requests, referring to the attached sequence numbers at Step S8402. The sequence control modules 7132 and 7232 recover the standard data processing requests for the corresponding data processing requests attached with the sequence numbers, in the order indicated by the sequence numbers. The sequence control modules 7132 and 7232 forward the standard data processing requests to the DB connection modules 7133 and 7233, respectively.

The DB connection modules 7133 and 7233 convert the standard data processing requests received into corresponding DBMS-specific data processing requests, and forward the DBMS-specific data processing requests to the DBMSs 7110 and 7210, respectively at Step S8403.

Upon receiving the DBMS-specific data processing requests, the DBMSs 7110 and 7210 performs the same processing on the data stored in the storages 7120 and 7220 in accordance with the received DBMS-specific data processing requests, at Step S8404. The above-described operation equivalently achieves data replication of the data stored in the primary storage 7120 into the backup storage 7220.

The DBMSs 7110 and 7210 return DBMS-specific data processing responses indicative of the results of the data processing to the DB connection modules 7133 and 7233, respectively, at Step S8405. The DB connection modules 7133 and 7233 convert the DBMS-specific data processing responses into standard data processing responses, and forward the standard data processing responses to the interface modules 7131 and 7231, respectively, at Step S8406.

The interface modules 7131 and 7231 respectively forward the received standard data processing responses to the associated application server 7300-i, at Step S8407. Upon receiving standard data processing responses, the interface modules 7321 and 7322 within the application server 7300-i respectively forward the standard data processing responses to the control module 7323 at Step S8302. The control module 7323 is in the waiting state, until receiving the data processing responses from both of the interface modules 7321 and 7322 at Step S8105.

After receiving both of the data processing responses, the control module 7323 returns one of the data processing responses to the application 7310 at Step S8106. When the data processing is successfully completed in both of the database servers 7100 and 7200, the responses from the database servers 7100 and 7200 are logically identical, and therefore, the standard data processing responses corresponding thereto are also identical. Therefore, it is not important which of the data processing responses received from the interface modules 7321 and 7322 is returned to the application 7310.

The application 7310 provides a desired service in response to the received data processing response at Step S8107. The application 7310 receives one data processing response for one data processing request, and therefore, the application 7310 is not designed specially for data replication.

The above-described operation achieves assigning sequence numbers uniquely defined over the system to the respective standard data processing requests, and allows the database servers to process the standard data processing requests in the order indicated by the sequence numbers.

One advantage of the computer system in the first embodiment is that the order of processing the data processing requests in the primary DBMS is kept identical to the order of processing the data processing requests in the backup DBMS. Although there is a difficulty in that the respective DBMSs may operate on database-specific protocols, the computer system architecture effectively overcomes the difficulty. In this computer system, the protocol of issuing standard data processing requests, whose specification is disclosed in the public domain, is modified so as to assign sequence numbers within the application servers, and the database servers are designed to recover the standard data processing requests therein, and to perform data processing in the order indicated by the sequence numbers.

Another advantage is that the above-described computer system architecture allows continuously providing desired services; when one of the database servers 7100 and 7200 experiences trouble, the other provides desired data for the application 7310.

Another advantage is that the data replication architecture in the above-described computer system is widely applicable to various computer systems, incorporating various kinds of DBMSs and applications, without modification of the DBMSs and applications. The above-described computer architecture provides data replication function for database computers installed with DBMSs which do not originally support data replication, and for database computers which are installed with different kinds of DBMSs.

### Second Embodiment

### (System Structure)

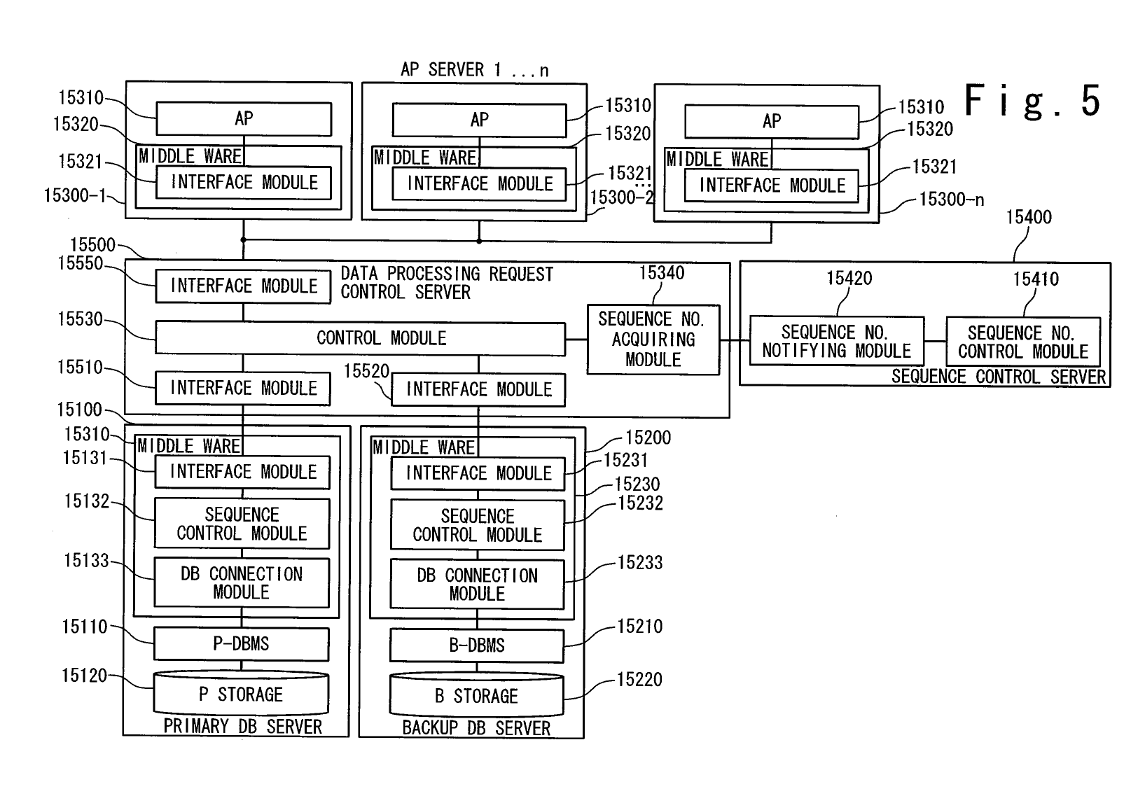

FIG. 5 is a block diagram illustrating a computer system in a second embodiment. The computer system in this embodiment is featured by including a data processing request control server which concentratedly manages data processing requests received from application servers.

Specifically, the computer system in this embodiment is composed of n application servers 15300-1 to 15300-n, a primary database server 15100, a backup database server 15200, a sequence control server 15400, and a data processing request control server 15500. The application servers 15300-1 to 15300-n provide users with desired services. The primary database server 15100 provides desired data for the application servers 15300-1 to 15300-n. The backup database server 15200 functions as a duplicate of the primary database server 15100. The sequence control server 15400 manages the order of data processing requests issued by the application servers 15300-1 to 15300-n through allocating sequence numbers to the respective data processing requests. The application servers 15300-1 to 15300-n, the database servers 15100, 15200, the sequence control server 15400, and the data processing request control server 15500 may be implemented as physically separate computers, or as a single computer.

The primary database server 15100 is provided with a storage 15120 storing data, a DBMS 15110 manages the data in the storage 15120, and a middleware 15130 accommodating data processing requests. The storage 15120, the DBMS 15110, and the middleware 15130 operate identically to the corresponding components in the primary database server 7100 in the first embodiment,

The backup database server 15200 is provided with a storage 15220 storing data, a DBMS 15210 managing the data in the storage 15220, and a middleware 15230 accommodating data processing requests. The storage 15220, the DBMS 15210, and the middleware 15230 operate identically to the corresponding components in the backup database server 7200 in the first embodiment.

The application servers 15300-1 to 15300-n are each provided with an application 15310, and a middleware 15320 commonly providing functions for multiple applications, including the application 15310. The middleware 15320 includes interface modules 15321.

The sequence control server 15400 is provided with a sequence number control module 15410, and a sequence number notifying module 15420, which operate identically to the corresponding components in the sequence control server 7400 in the first embodiment.

The data processing request control server 15500 is provided with interface modules 15510 and 15520, a control module 15530, and a sequence number acquiring module 15340, which operate identically to corresponding components in the middleware 7320 in the first embodiment. Additionally, the data processing request control server 15500 includes interface module 15550 receiving data processing requests from the application servers 15300-1 to 15300-n, and transmitting data processing responses to the application servers 15300-1 to 15300-n.

### (System Operation)

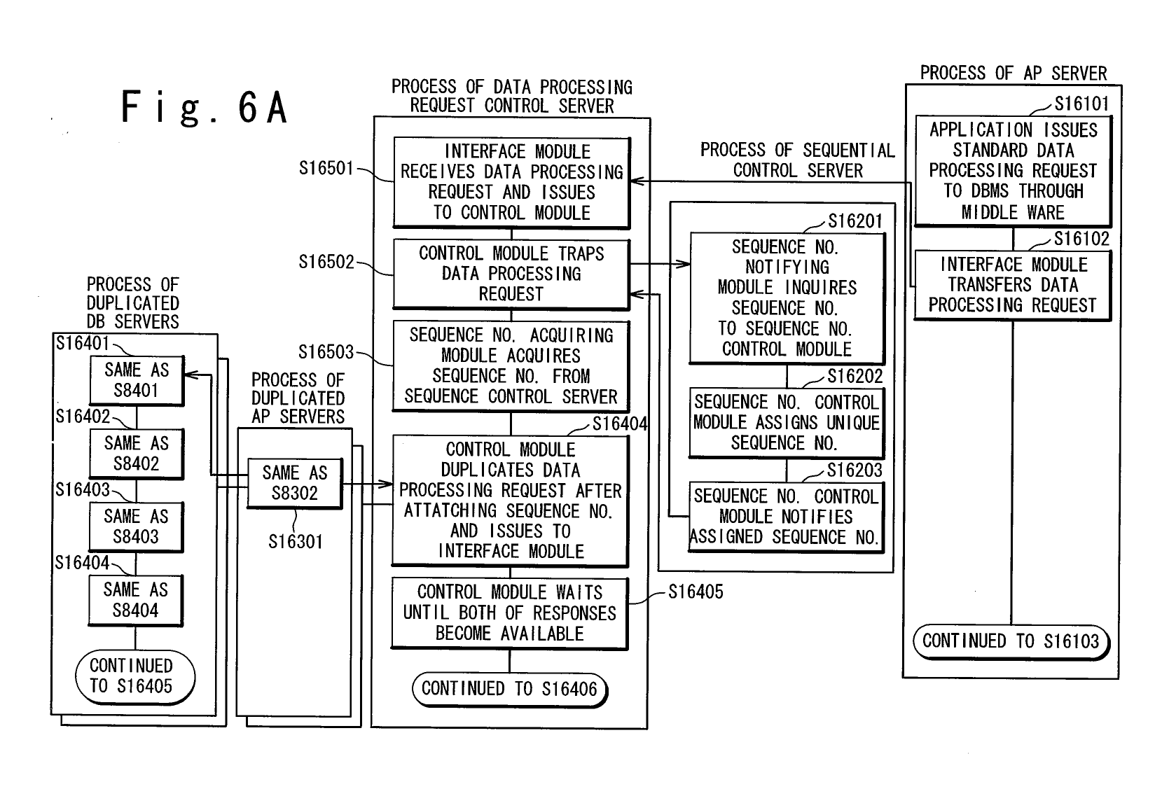

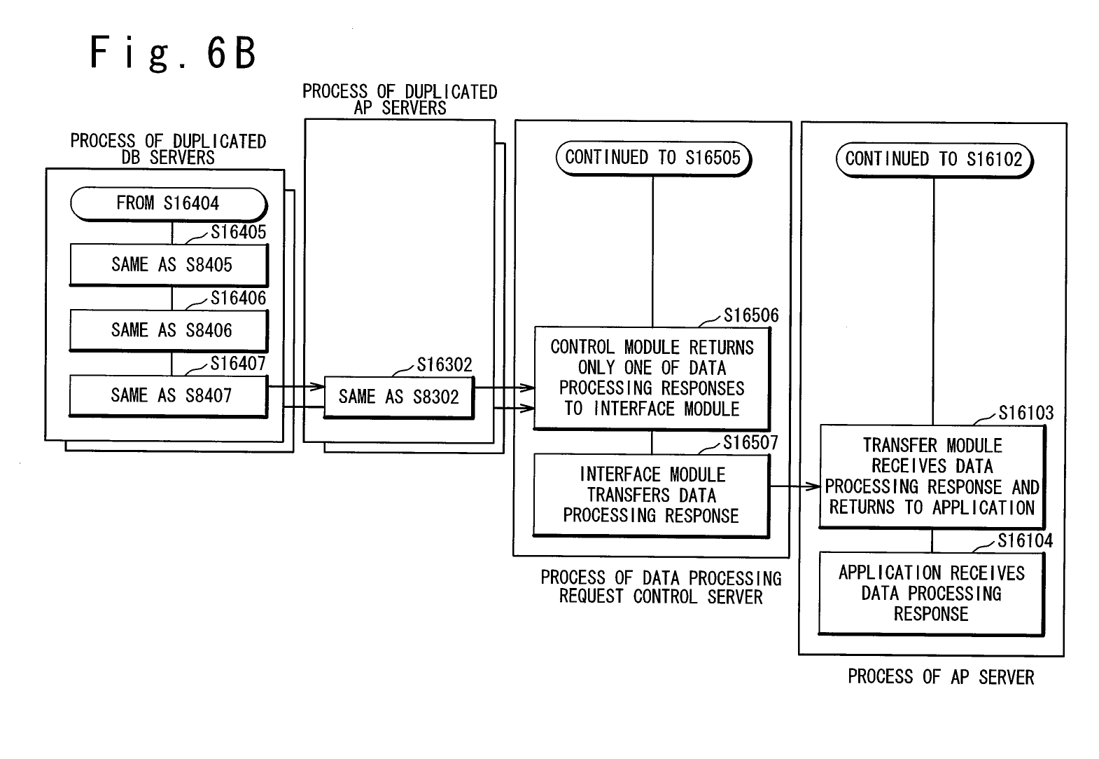

FIGS. 6A and 6B are flowchart illustrating the operation of the computer system in the second embodiment.

The application 15310 within the application server 15300-1 issues a standard data processing request to the middleware 15320 at Step S16101, when requesting data processing to the primary DBMS 15100. The issued standard data processing request is adapted to the standardized interface used by DB connection modules 15133 within the middleware 15130.

Upon the middleware 15320 receiving the standard data processing request, the interface module 15321 forwards the received data processing request to the data processing request control server 15500 at Step S16102.

The interface module 15550 within the data processing request control server 15500 forwards the received data processing request to the control module 15530 at Step S16501. Thereafter, the data processing request control server 15500 operates similarly to the middlewares 7320 in the application servers 7300-1 to 7300-n in the first embodiment, while the sequence control server 15400 and the database servers 15100 and 15200 operate similarly to the sequence control server 7400 and the database servers 7100 and 7200, respectively. The operations of the data processing request control server 15500 at Steps S16502 to S16505 are identical to the operations of the application servers 7300 at Steps S8102 to S8105 in the first embodiment. The operations of the sequence control server 15400 at Steps S16201 to S16203 are identical to the operation of the sequence control server 7400 at Steps S8201 to S8203 in the first embodiment. The operations of the data processing request control server 15500 at Steps S16301 to S16302 are identical to the operations of the application servers 7300 at Steps S8201 to S8202 in the first embodiment. The operations of the database servers 15100 and 15200 at Steps S16401 to S16407 are identical to the operations of the database servers 7100 and 7200 at Steps S8401 to S8407 in the first embodiment.

After receiving the data processing responses from both of the primary and backup database servers 15100 and 15200, the control module 15530 returns one of the data processing responses to the interface module 15550 at Step S16506. When the data processing is successfully completed in both of the database servers 15100 and 15200, the responses from the database servers 15100 and 15200 are logically identical, and therefore, the standard data processing responses corresponding thereto are also identical. Therefore, it is not important which of the data processing responses received from the database servers 15100 and 15200 is returned to the interface module 15550.

The interface module 15550 returns the received data processing response to the application 15310 at Step S16103. The application 15310 provides a desired service in response to the received data processing response at Step S16104. The application 15310 receives one data processing response for one data processing request, and therefore, the application 7310 is not designed specially for data replication.

The above-described operation achieves assigning sequence numbers uniquely defined over the system to the respective standard data processing requests, and allows the database servers to process the standard data processing requests in the order indicated by the sequence numbers.

The computer system in the second embodiment enjoys the same advantages as the computer system in the first embodiment. Additionally, the computer system in the second embodiment effectively improves maintainability due to the concentration of the data processing request control into the data processing request control server. Additionally, the computer system in the second embodiment effectively reduces the loads on the application servers, due to the data processing request control independent from the application servers.

### Third Embodiment

### (System Structure)

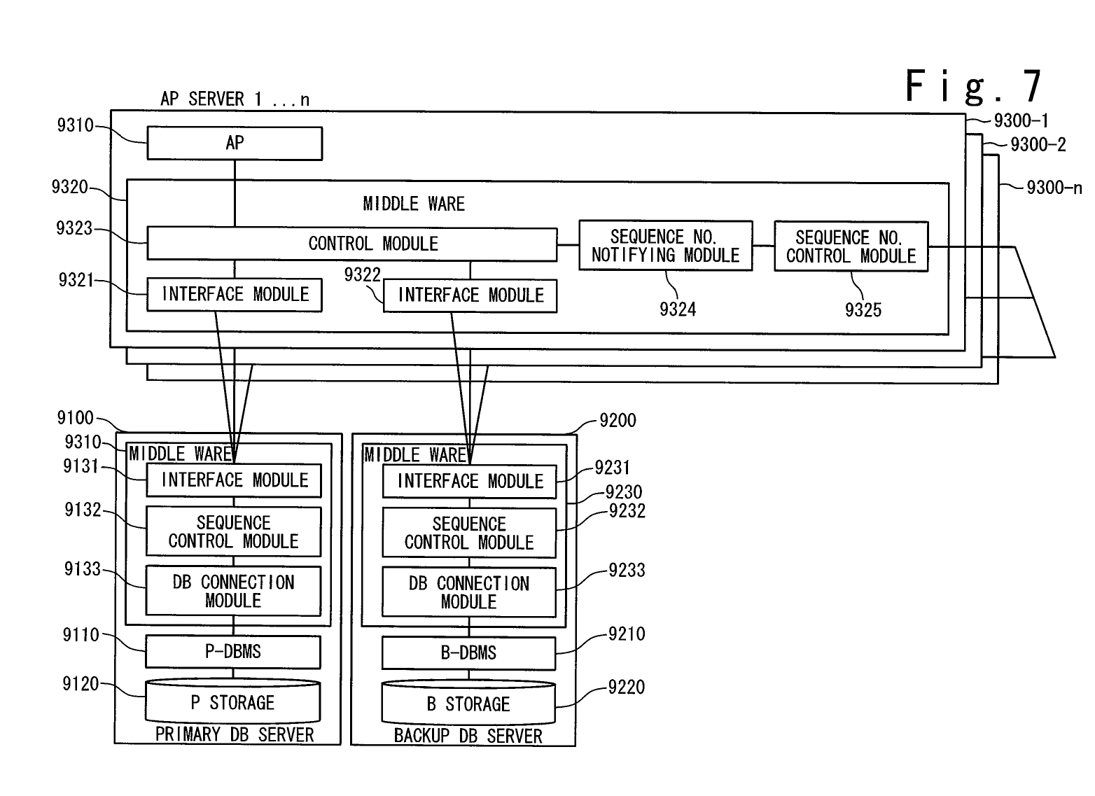

FIG. 7 is a block diagram illustrating a computer system in a third embodiment of the present invention. The computer system in the third embodiment is featured in that the assignment of the sequence numbers is accomplished in the respective application servers instead of the sequence control server.

Specifically, the computer system in the third embodiment is composed of n application servers 9300-1 to 9300-n, a primary database server 9100, and a backup database server 9200. The application servers 9300-1 to 9300-n provide users with desired services. The primary database server 9100 provides desired data for the application servers 9300-1 to 9300-n. The backup database server 9200 functions as a duplicate of the primary database server 9100. The application servers 9300-1 to 9300-n, and the database servers 9100, 9200 may be implemented as physically separate computers, or as a single computer.

The primary database server 9100 is provided with a storage 9120 storing data, a DBMS 9110 managing the data in the storage 9120, and a middleware 9130 accommodating data processing requests. The storage 9120, the DBMS 9110, and the middleware 9130 operate identically to the corresponding components of the primary database servers 7100 in the first embodiment.

The backup database server 9200 is provided with a storage 9220 storing data, a DBMS 9210 managing the data in the storage 9220, and a middleware 9230 accommodating data processing requests. The storage 9220, the DBMS 9210, and the middleware 9230 operate identically to the corresponding components of the backup database servers 7300 in the first embodiment.

The application servers 9300-1 to 9300-n are each provided with an application 9310, and a middleware 9320 commonly providing functions for multiple applications, including the application 9310.

The middleware 9320 includes interface modules 9321 and 9322, a control module 9323, and a sequence number acquiring module 9324, which operate identically to the corresponding components of the middleware 7320 in the first embodiment. The middleware 9320 additionally includes a sequence number negotiating module 9325. The middleware 9320 of a certain application server negotiates the assignment of sequence numbers with the middleware 9320 of the other application servers.

### (System Operation)

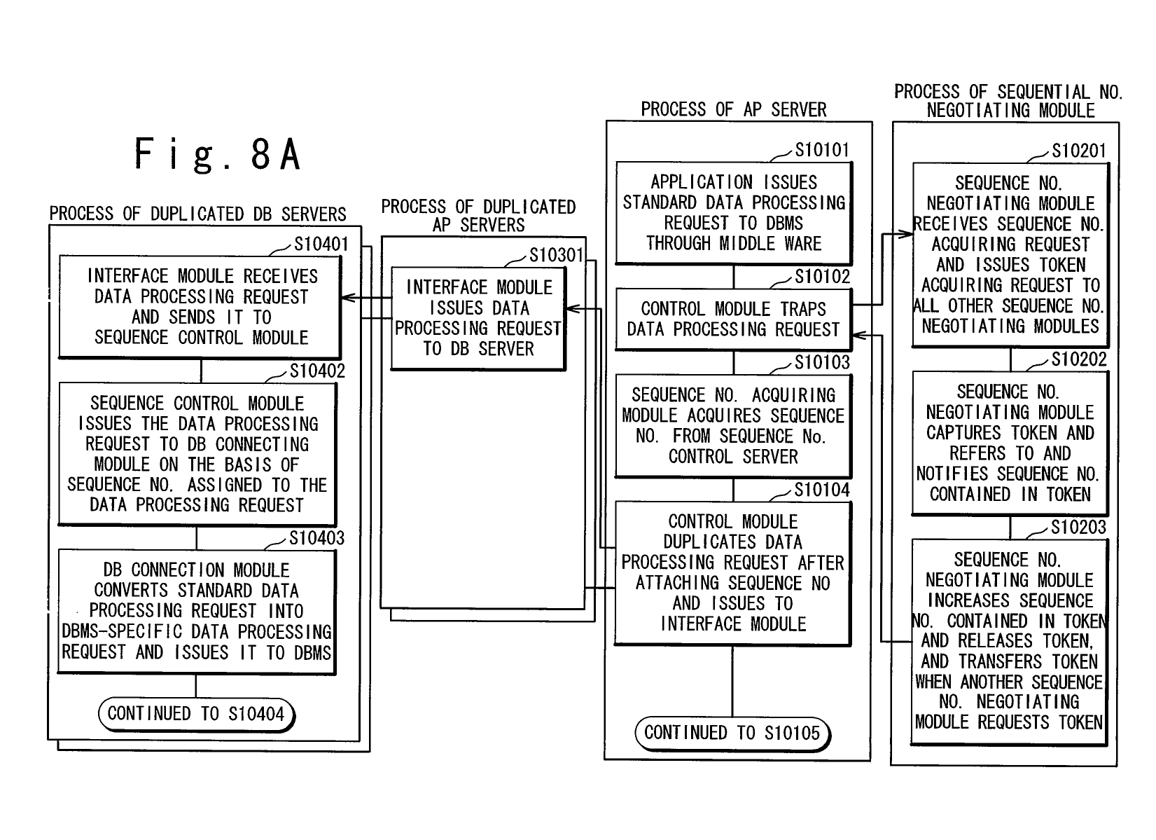

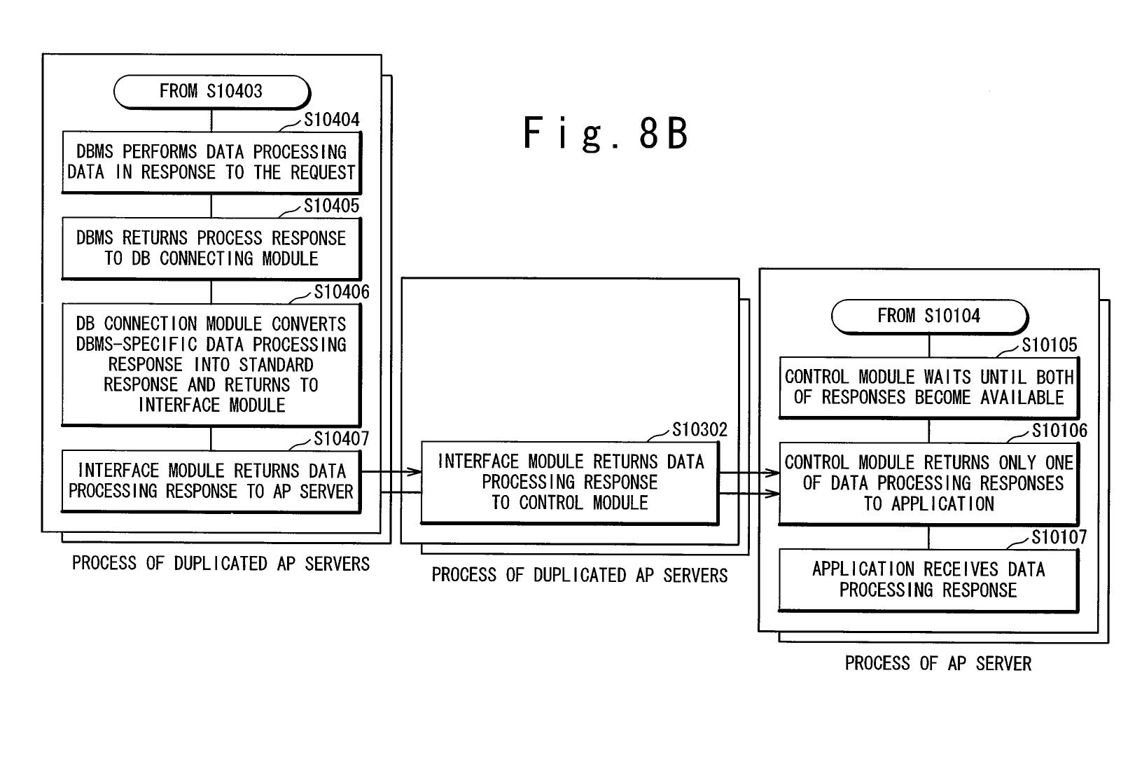

FIGS. 8A and 8B are flowchart illustrating the operation of the computer system in the third embodiment.

The operation of the computer system in the third embodiment is similar to that in the first embodiment except for that the assignment of sequence numbers is achieved by the sequence number negotiating modules 9325 in the application servers 9300, instead of the sequence control server 7400. The operations of the application servers 9300 at Steps S10101 to S10107, and S10301 to S10302 are identical to those of the application servers 7300 at Step S8101 to S8107 and S8301 to S8302 in the first embodiment, respectively (See FIGS. 4A and 4B). Furthermore, the operations of the database servers 9100 and 9200 at Step S10401 to S10407 are identical to those of the database servers 7100 and 7200 at Step S8401 to S8407, respectively.

A sequence number negotiating module 9325 in a certain application server 9300 negotiates sequence number assignment with other sequence number negotiating modules 9325 in the other application servers 9300 to thereby assign a sequence number uniquely defined over the whole of the system to a relevant data processing request. In one embodiment, the negotiation is achieved by an object-oriented approach using a token. The token is an only object containing a sequence number, which is allowed to travel over all the application servers 9300-1 to 9300-n. There is only one token over the whole of the system. When a specific sequence number negotiating module 9323 in a specific application server 9300 receives a sequence number assignment request, the specific sequence number negotiating module 9323 requests the other sequence number negotiating modules 9323 in the other application servers 9300 to permit capturing the token at Step S10201.

When the token is available, the specific sequence number negotiating module 9323 captures the token and notifies the sequence number contained by the token to the relevant sequence number acquiring module 9324 at Step S10202. When the token is not available, the specific sequence number negotiating module 9323 is placed into a waiting state until the token becomes available.

After notifying the sequence number, the specific sequence number negotiating module 9323 increments the sequence number contained by the token by one, and releases the token at Step S10203. When the specific sequence number negotiating module 9323 is requested to permit capturing the token by any of the sequence number negotiating modules 9323 in the system after releasing the token, the specific sequence number negotiating module 9323 sends the token to the requesting sequence number negotiating module 9323.

The above-described operation achieves assigning sequence numbers uniquely defined over the system to the respective standard data processing requests, and allows the database servers to process the standard data processing requests in the order indicated by the sequence numbers.

The computer system in the third embodiment enjoys the same advantages as the computer system in the first embodiment. Additionally, the computer system in the third embodiment effectively improves system availability, because the function of the sequence number assignment is distributed over the computer system in the third embodiment. When the sequence control server experiences trouble, the whole of the computer system may be disabled in the first and second embodiments; however, the computer system in the third embodiment is free from such problem.

It is apparent that the present invention is not limited to the above-described embodiments, which may be modified and changed without departing from the scope of the invention. The following is a description of exemplary modifications.

In an alternative embodiment, the functions of the sequence control server and/or the data processing request control server may be implemented by one of the application servers and the database servers.

In another alternative embodiment, the computer system may be provided with multiple sequence control servers. In this case, when one of the sequence control servers experiences trouble and stops operating, another sequence control server may automatically start to implement the sequence number assignment operation instead.

In still another alternative embodiment, the computer system may be designed to switch the sequence number assignment operation. In one embodiment, a sequence control server may perform the sequence number assignment during normal operations. When the sequence control server experiences trouble, the application servers start to achieve the sequence number assignment by the negotiation among the middlewares thereof.

The procedure of the sequence number assignment is not limited to those described above. In still another alternative embodiment, the sequence number assignment may be achieved by a sequence control protocol disclosed by Xavier Defago et al. in “Totally Ordered Broadcast and Multicast Algorithms: A Comprehensive Survey”, Technical Report DSC, Ecole Polytechnique Federale de Lausannne, 2000.

Although the computer system described above adopts a “one to one structure” in which one backup database server is provided for one primary database server, the structure of the database server system may be modified. A description is made of preferred modifications of the database server system in the following:

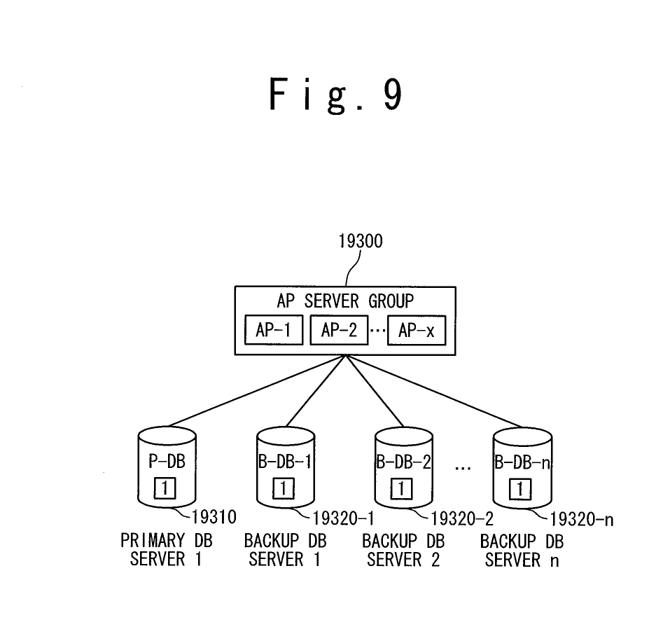

FIG. 9 illustrates the structure of a computer system in a first modification, which adopts a “one to N structure”. Specifically, the computer system in FIG. 9 is provided with a set of application servers 19300, a primary database server 19310, and multiple backup servers 19320-1 to 19320-n. Data stored in the primary database server 19310 are duplicated and stored into each of the backup servers 19320-1 to 19320-n.

In this modification, the applications installed within the application servers 19300 duplicatedly issue data processing requests for each of the backup servers 19320-1 to 19320-n.

The duplicated backup servers 19320-1 to 19320-n in this modification advantageously allow the computer system to continuously provide desired services, when the primary database server and one of the backup servers experience trouble at the same time.

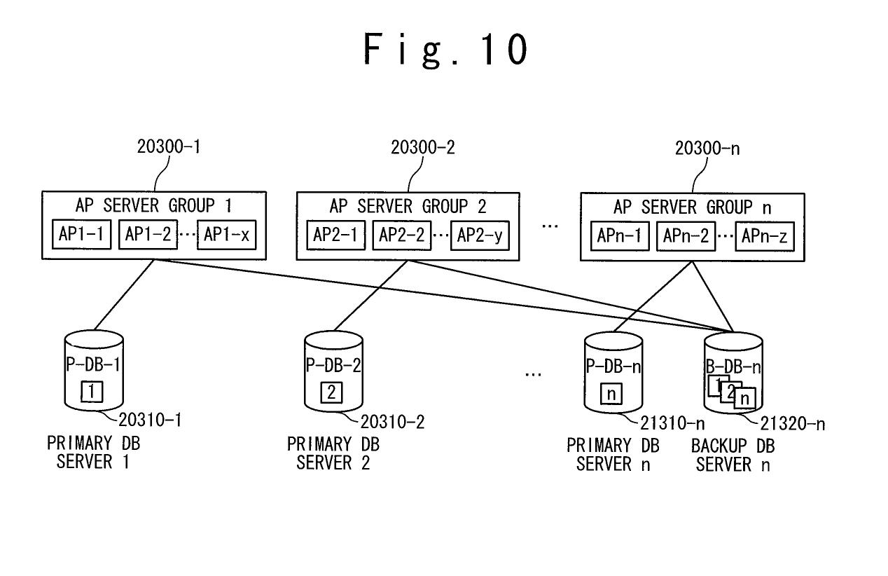

FIG. 10 illustrates a computer system in a second modification, which adopts an “N to one structure”. Specifically, the computer system in the second modification is provided with multiple sets of application servers 20300-1 to 20300-n, multiple primary database servers 20310-1 to 20310-n, and a backup database server 20320. Data stored in all of the primary database servers 20310-1 to 20310-n are duplicated and concentratedly stored into the backup database server 20320.

In this modification, the backup database server 20320 includes multiple regions associated with the primary database servers 20310-1 to 20310-n, respectively. When receiving a data processing request from the application servers 20300-1 to 20300-n, the backup database server 20320 perform desired processing in accordance with the received request on associated one(s) of the regions.

The computer system architecture in this modification eliminates the need for providing the same number of the backup database servers as the primary database servers, and effectively reduces the cost of the system construction.

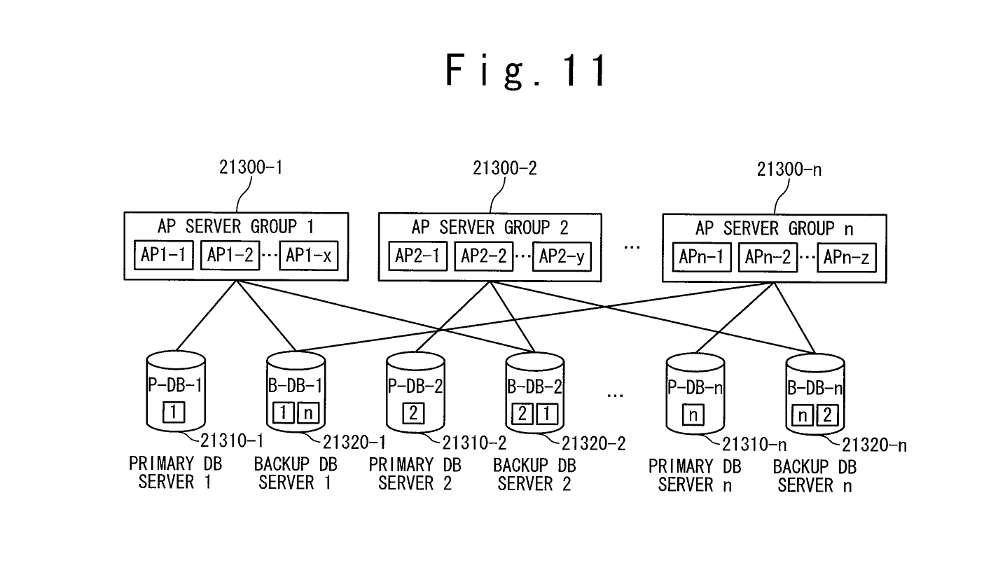

FIG. 11 is a block diagram illustrating a computer system in a third modification, which adopts an “N to M structure”. Specifically, the computer system in FIG. 11 is provided with multiple sets of application servers 21300-1 to 21300-n, multiple primary database servers 21310-1 to 21310-n, and multiple backup database servers 21320-1 to 21320-m.

Data stored in each of the primary database servers 21310-1 to 21310-n are duplicated and stored in one or more of the backup database servers 21320-1 to 21320-m.

In this modification, each application of the application servers 20300-1 to 20300-n issues the same data processing requests to one or more of the backup database servers 21320-1 to 21320-m. Each of the backup database servers 21320-1 to 21320-m includes multiple regions. When receiving the data processing request from an application of the application servers 21300-1 to 21300-n, the backup database server 20320 performs desired processing in accordance with the received request on associated one(s) of the regions.

The computer system in this embodiment is superior in fail-safe performance due to the multiple backup database servers, as is the case of the “one to N structure”. Additionally, the computer system in this embodiment effectively reduces the cost of the system, due to the concentrated storage of the duplicated data, as is the case of the “N to one structure”.

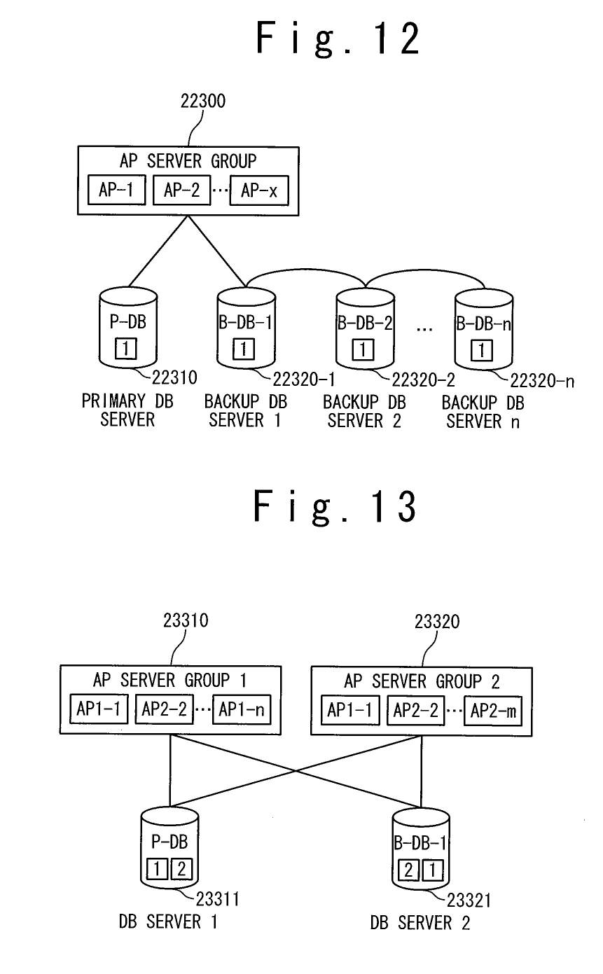

FIG. 12 illustrates the structure of a computer system in a fourth modification, which adopts a “chain structure”. Specifically, the computers system in FIG. 12 is provided with a set of application servers 22300, a primary database server 22310, and serially-connected backup database servers 22320-1 to 22320-n.

Data stored in the primary database servers 22310 are duplicated and stored in each of the backup database servers 22320-1 to 22320-n.

In this embodiment, each of the backup database servers 22320-1 to 22320-n is designed to forward a data processing request to another backup database server, when receiving the data processing request from an application of the application servers 22300.

The computer system in this modification is superior in fail-safe performance due to the multiple backup database servers, as is the case of the “one to N structure”. Additionally, the computer system in this modification effectively distributes the load required for issuing data processing requests. Each application within the application servers 22300 issues a data processing request to only one of the backup database servers, while each of the backup database servers forwards the data processing request to only one of the other backup database servers.

FIG. 13 illustrates a structure of a computer system in a fifth modification, which adopts a “mutual structure”. Specifically, the computer system in the fifth modification is provided with sets of application servers 23310 and 23320, and a pair of database servers 23311, and 233211. Data stored in the database server 23311 are duplicated and stored in the database server 23321, while data stored in the database server 23321 are duplicated and stored in database server 23311.

In this embodiment, the application servers 23310 use the database server 23311 as a primary database server, while using the database server 23321 as a backup database server. Reversely, the application servers 23320 use the database server 23321 as a primary database server, while using the database server 23311 as a backup database server. The database servers 23311 and 23321 are composed of multiple regions, each designed to perform desired processing in accordance with a data processing request issued by the application servers 23310 and 23320 on associated one of the regions.

The computer system architecture in this embodiment can take advantage of the original performance thereof, by allowing the backup system to provide desired services through running applications thereon. Additionally, when two or more systems are each provided with a set of application servers and a database server, the computer system architecture in this embodiment allows the systems to achieve synchronous data replication. The computer system in this modification may include two or more such systems.

The respective modules within the computer system may be implemented as hardware, software programs, or a combination of hardware and software programs. The software programs may be commercially distributed in a computer-readable medium, such as a magnetic disk and a semiconductor non-volatile memory. When the computer system is booted, the software programs are read by the respective servers and used for operating the servers.

What is claimed is:

1. A computer system comprising:
a plurality of application servers each installed with an application program configured to issue data processing requests; and
a plurality of database servers each including a storage, and each installed with a database server middleware receiving said data processing requests and a DBMS managing data stored in said storage,
wherein each of said data processing requests is duplicatedly forwarded to each of said database servers,
wherein sequence numbers uniquely defined over the whole of said computer system are respectively assigned to said data processing requests received by said database middlewares, and
wherein said database server middleware converts said data processing requests received into corresponding DBMS-specific data processing requests, and forwards said DBMS-specific data processing requests in an order indicated by said sequence numbers.

2. The computer system according to claim 1, further comprising a data processing request control server connected between said application servers and said database servers,
wherein said data processing request control server is configured to attach said data processing requests with assigned ones of said sequence numbers, to duplicate each of said data processing requests attached with said sequence numbers, and to forward said duplicated data processing requests to each of said database servers.

3. The computer system according to claim 1, further comprising a sequence control server assigning said sequence numbers to said data processing requests issued by said application programs.

4. The computer system according to claim 1, wherein said application servers each include a sequence number negotiating module, and
wherein one of said sequence number negotiating modules negotiates with other(s) of said sequence number negotiating modules to achieve assignment of said sequence numbers to said data processing requests.

5. The computer system according to claim 1, further comprising a sequence number control server including a sequence number control module assigning said sequence numbers uniquely defined to said data processing requests issued by said application programs,
wherein said plurality of application servers each includes application server middleware comprising:
a sequence number acquiring module acquiring said sequence numbers from said sequence control server; and
a control module configured to attach said data processing requests received from said application program with said sequence numbers, to duplicate said data processing requests attached with said sequence numbers, and to forward each of said duplicated data processing requests to each of said database servers, and
wherein said database server middleware comprises:
a sequence control module rearranging an order of said data processing requests attached with said sequence numbers, in response to said sequence numbers; and
a DB connection module converting said data processing requests received into said DBMS-specific data processing requests.

6. The computer system according to claim 1, further comprising:
a sequence control server; and
a data processing request control server connected between said application servers and said database servers,
wherein said sequence control server includes:
a sequence number control module assigning said sequence numbers uniquely defined to said data processing requests received by said database middlewares,
wherein said plurality of application servers each includes application server middleware forwarding said data processing requests received from said application program to said data processing request control server,
wherein said data processing request control server includes:
a control module configured to attach said data processing requests received from said application server middleware with said sequence numbers, to duplicate said data processing requests attached with said sequence numbers, and to forward each of said duplicated data processing requests to each of said database servers, and
wherein said database server middleware comprises:
a sequence control module rearranging an order of said data processing requests attached with said sequence numbers, in response to said sequence numbers; and
a DB connection module converting said data processing requests received from said sequence control module into said DBMS-specific data processing requests.

7. The computer system according to claim 1,
wherein said plurality of application servers each includes application server middleware comprising:
a sequence number negotiating module negotiating with other one(s) of said application servers to achieve assignment of said sequence numbers to said data processing requests; and
a control module configured to attach said received data processing requests with said sequence numbers, to duplicate said data processing requests attached with said sequence numbers, and to forward each of said duplicated data processing requests to each of said database servers, and
wherein said database server middleware comprises:
a sequence control module rearranging an order of said data processing requests attached with said sequence numbers, in response to said sequence numbers; and
a DB connection module converting said data processing requests received into said DBMS-specific data processing requests.

8. A method of achieving data replication comprising:
issuing data processing requests by application programs within a plurality of application servers;
assigning sequence numbers to said respective data processing requests;
duplicatedly forwarding each of said data processing requests attached with said sequence numbers to each of database servers;
converting said data processing requests attached with said sequence numbers into corresponding DBMS-specific data processing requests; and
forwarding said DBMS-specific data processing requests to DBMSs within said database servers in an order indicated by said sequence numbers.

9. The method according to claim 8, wherein said duplicatedly forwarding is implemented by application server middlewares installed within said application servers, respectively.

10. The method according to claim 8, wherein said duplicatedly forwarding is implemented by a data processing request control server connected between said application servers and said database servers.

11. The method according to claim 8, wherein said assigning said sequence numbers is implemented by a sequence control server.

12. The method according to claim 8, wherein said application servers are respectively installed with application server middlewares each including a sequence number negotiating module, and
wherein assignment of said sequence numbers is achieved through negotiation between or among said sequence number negotiating modules.

13. An application server comprising:
an application program configured to issue data processing requests; and
middleware including:
a sequence number acquiring module receiving sequence numbers assigned to said data processing requests from a sequence control server; and
a control module configured to attach said received data processing requests with said sequence numbers, to duplicate said data processing requests attached with said sequence numbers, and to forward each of said duplicated data processing requests to each of a plurality of database servers.

14. An application server comprising:
an application program configured to issue data processing requests; and
middleware including:
a sequence number negotiating module negotiating assignment of sequence numbers to said data processing requests with at least one other sequence number negotiating module installed in at least one other application server; and
a control module configured to attach said data processing requests with said sequence numbers, to duplicate said data processing requests attached with said sequence numbers, and to forward each of said duplicated data processing requests to each of a plurality of database servers.

15. A data processing request control server comprising:
a sequence number acquiring module receiving sequence numbers from a sequence control server, said sequence numbers being assigned to data processing requests issued by application programs installed in application servers; and
a control module configured to attach said data processing requests with said sequence numbers, to duplicate said data processing requests attached with said sequence numbers, and to forward each of said duplicated data processing requests to each of a plurality of database servers.

16. A database server comprising:
a storage;
a DBMS managing data stored in said storage; and
middleware configured to receive data processing requests attached with sequence numbers from a plurality of application servers,
wherein said middleware includes:
a sequence control module rearranging an order of said data processing requests attached with sequence numbers, in response to said sequence numbers; and
a DB connection module converting said data processing requests received from said sequence control module into DBMS-specific data processing requests, and forwarding said DBMS-specific data processing requests in an order indicated by said sequence numbers to said DBMS.

17. A database server comprising:
a storage;
a DBMS managing data stored in said storage; and
middleware configured to receive data processing requests attached with sequence numbers from a data processing request control server,
wherein said middleware includes:
a sequence control module rearranging an order of said data processing requests attached with sequence numbers, in response to said sequence numbers; and
a DB connection module converting said data processing requests received from said sequence control module into DBMS-specific data processing requests, and forwarding said DBMS-specific data processing requests in an order indicated by said sequence numbers to said DBMS.

18. A computer-readable medium recording a program for an application server, said program comprising:
a code module for receiving sequence numbers assigned to data processing requests issued by an application program installed in said application server, from a sequence control server; and
a code module for attaching said received data processing requests with said sequence numbers, for duplicating said data processing requests attached with said sequence numbers, and for forwarding each of said duplicated data processing requests to each of a plurality of database servers.

19. A computer-readable medium recording a program for an application server, said program comprising:
a code module for negotiating assignment of sequence numbers to data processing requests issued by an application program installed in said application server with at least one other sequence number negotiating module installed in at least one other application server; and
a code module for attaching said data processing requests with said sequence numbers, for duplicating said data processing requests attached with said sequence numbers, and for forwarding each of said duplicated data processing requests to each of a plurality of database servers.

20. A computer-readable medium recording a program for a data processing request control server, aid program comprising:
a code module for receiving sequence numbers from a sequence control server, said sequence numbers being assigned to data processing requests issued by application programs installed in application servers; and
a code module for attaching said data processing requests with said sequence numbers, for duplicating said data processing requests attached with said sequence numbers, and for forwarding each of said duplicated data processing requests to each of a plurality of database servers.

21. A computer-readable medium recording a program for a database server including a storage and a DBMS managing data stored in said storage, said program comprising:
a code module for receiving data processing requests attached with sequence numbers from a plurality of application servers;
a code module for rearranging an order of data processing requests attached with sequence numbers, in response to said sequence numbers; and
a code module for converting said data processing requests received from said sequence control module into DBMS-specific data processing requests, and for forwarding said DBMS-specific data processing requests in an order indicated by said sequence numbers to said DBMS.

22. A computer-readable medium recording a program for a database server including a storage and a DBMS managing data stored in said storage, said program comprising:
a code module for receiving data processing requests attached with sequence numbers from a data processing request control server;
a code module for rearranging an order of data processing requests attached with sequence numbers, in response to said sequence numbers; and
a code module for converting said data processing requests received from said sequence control module into DBMS-specific data processing requests, and for forwarding said DBMS-specific data processing requests in an order indicated by said sequence numbers to said DBMS.
